(19) United States
(12) Patent Application Publication
(10) Pub. No.: US 2024/0151184 A1
(43) Pub. Date: May 9, 2024

(54) METHOD OF DETERMINING AN OPERATING CONDITION OF A VALVE OF AN AIRCRAFT SYSTEM

(71) Applicants: Airbus Operations Limited, Bristol (GB); Airbus Operations (S.A.S.), Toulouse (FR)

(72) Inventors: Petros Manaras, Toulouse (FR); Brian Sagar, Bristol (GB)

(21) Appl. No.: 18/519,489

(22) Filed: Nov. 27, 2023

Related U.S. Application Data
(63) Continuation of application No. PCT/EP2022/062441, filed on May 9, 2022.

(30) Foreign Application Priority Data
May 27, 2021 (GR) 20210100354

(51) Int. Cl. F02C 7/232; B64D 37/00; B64F 5/60; F16K 37/00

(52) U.S. Cl. CPC F02C 7/232; B64D 37/005; B64F 5/60; F16K 37/0083; F05D 2260/80

(57) ABSTRACT

A method of determining an operating condition of a valve of an aircraft system includes obtaining a first time period associated with actuating the valve, and a second time period associated with actuating the valve. The method includes providing an indication of an altered operating condition associated with actuation of the valve based on the first and second time periods.

### TECHNICAL FIELD

The disclosure herein relates to a method of determining an operating condition of a valve of an aircraft system, and an aircraft system.

### BACKGROUND

Aircraft systems may comprise valves to control the flow of fluid between different components of the aircraft system. For example, aircraft fuel systems may comprise multiple fuel storage tanks, and fuel may be moved between the fuel storage tanks in-flight to maintain or obtain desired flight properties such as to trim the aircraft to obtain a desired attitude of the aircraft. Such fuel storage tanks typically have valves that control flow of fluid into and out of the fuel storage tank.

### SUMMARY

A first aspect of the disclosure herein provides a method of determining an operating condition of a valve of an aircraft system, the method comprising: obtaining a first time period associated with actuating the valve, and a second time period associated with actuating the valve; and providing an indication of an altered operating condition associated with actuation of the valve based on the first and second time periods.

The first time period may be associated with a first actuation of the valve, and the second time period may be associated with a second actuation of the valve different to the first actuation of the valve.

The valve may be actuable between first and second positions, the first time period may be associated with a first actuation of the valve from the first position to the second position or vice versa, and the second time period may be associated with a second actuation of the valve from the first position to the second position or vice versa.

The method may comprise comparing each of the first and second time periods to a threshold value, and where each of the first and second time periods exceeds the threshold value, providing the indication of the altered operating condition associated with actuation of the valve.

The first time period may be associated with actuating the valve during a first flight in which the aircraft system is utilized, and the second time period may be associated with actuating the valve during a second flight in which the aircraft system is utilized, the second flight different to the first flight.

The method may comprise providing the indication of the altered operating condition associated with actuation of the valve where the first and second flights occur within a pre-determined time window.

The valve may be actuated a plurality of times in the first flight, the method may comprise obtaining a first plurality of time periods each corresponding to a respective actuation of the valve during the first flight, and selecting the first time period from the first plurality of time periods based on a length of each of the first plurality of time periods. The valve may be actuated a plurality of times in the second flight, the method may comprise obtaining a second plurality of time periods each corresponding to a respective actuation of the valve during the second flight, and selecting the second time period from the second plurality of time periods based on a length of each of the second plurality of time periods.

The method may comprise obtaining at least four different time periods associated with actuating the valve, each time period associated with actuating the valve during a different respective flight of a plurality of flights, comparing each time period to a corresponding threshold value, and, where each time period exceeds the threshold value and the plurality of flights occur within pre-determined time window, providing the indication of the altered operating condition associated with actuation of the valve.

The valve may be movable from a first position to a second position in response to a command, the first time period comprises a time taken for the valve to move from the first position to the second position, and the second time period comprises a time taken from issuance or receipt of the command to the valve reaching the second position.

The first time period may consist of the time taken for the valve to move from the first position to the second position. The second time period may consist of the time taken from issuance or receipt of the command to the valve reaching the second position.

The first time period and the second time period may be associated with a same actuation of the valve.

The method may comprise performing a comparison of the first time period to a parameter, and providing the indication of the altered operating condition associated with actuation of the valve based on the comparison.

The method may comprise performing a further comparison of the second time period to a further parameter, and providing the indication of the altered operating condition associated with actuation of the valve based on the comparison and the further comparison.

The parameter may comprise a nominal time taken for the valve to move from the first position to the second position, and the further parameter may comprise a nominal time taken from issuance or receipt of the command to the valve reaching the second position.

The method may comprise: where the first time period exceeds the parameter and the second time period exceeds the further parameter, providing an indication of a first altered operating condition associated with actuation of the valve; where the first time period exceeds the parameter and the second time period does not exceed the further parameter, providing an indication of a second altered operating condition associated with actuation of the valve different to the first altered operating condition associated with actuation of the valve; and where the first time period does not exceed the parameter and the second time period exceeds the further parameter, providing an indication of a third altered operating condition associated with actuation of the valve different to the first and second altered operating conditions of the valve.

The parameter may comprise the second time period, and/or the further parameter may comprise the first time period.

The valve may comprise first and second drivers, the first time period may be associated with actuation of the valve by the first and second drivers at a first point in time, the second time period may be associated with actuation of the valve by the first and second drivers at a second point in time different to the first point in time, and, where the second time period is greater than the first time period, the method may comprise providing an indication of an altered operating condition of at least one of the first and second actuators.

The aircraft system may comprise an aircraft fuel supply system.

A second aspect of the disclosure herein provides a data carrier comprising machine readable instructions for the operation of one or more processors of a controller of an aircraft system to obtain a first time period associated with actuating the valve, and a second time period associated with actuating the valve, and provide an indication of an altered operating condition associated with actuation of the valve based on the first and second time periods.

The controller may be configured to perform any of the actions described above as optional in relation to the first aspect of the disclosure herein.

A third aspect of the disclosure herein provides an aircraft system comprising a valve, a controller configured to obtain a first time period associated with actuating the valve, and a second time period associated with actuating the valve, and an indicator configured to provide an indication of an altered operating condition associated with actuation of the valve based on the first and second time periods.

The controller may be configured to perform any of the actions described above as optional in relation to the first aspect of the disclosure herein.

A fourth aspect of the disclosure herein provides an aircraft fuel system comprising a fuel storage tank, a conduit in fluid communication with the fuel storage tank, a valve to selectively enable transfer of fuel into and/or out of the fuel storage tank, the valve located within the conduit, a controller, and an indicator, the controller configured to monitor a plurality of time periods associated with actuation of the valve between an open position and a closed position, or vice versa, each of the plurality of time periods taken during a different flight of an aircraft comprising the aircraft fuel system, and compare each of the plurality of time periods to a corresponding parameter, and the indicator configured to provide an indication that the valve is operating in an altered operating condition relative to a normal operating condition of the valve based on the comparisons.

A fifth aspect of the disclosure herein provides an aircraft comprising the aircraft system of the third aspect of the disclosure herein or the aircraft fuel system of the fourth aspect of the disclosure herein.

### BRIEF DESCRIPTION OF THE DRAWINGS

Embodiments of the disclosure herein will now be described, by way of example only, with reference to the accompanying drawings, in which:

FIG. 1 shows a schematic view of a first aircraft fuel system;

FIG. 2 shows actuation of a valve of the first aircraft fuel system of FIG. 1;

FIG. 3 shows a method of determining an altered operating condition of a valve of the first aircraft fuel system of FIG. 1;

FIG. 4 shows a first graph illustrating time periods associated with actuation of a valve of the first aircraft fuel system of FIG. 1;

FIG. 5 shows a second graph illustrating time periods associated with actuation of a valve of the first aircraft fuel system of FIG. 1;

FIG. 6 shows a schematic view of a second aircraft fuel system;

FIG. 7 shows a schematic view of an aircraft comprising the first aircraft fuel system of FIG. 1 or the second aircraft fuel system of FIG. 6; and

FIG. 8 shows a schematic view of a data carrier.

### DETAILED DESCRIPTION

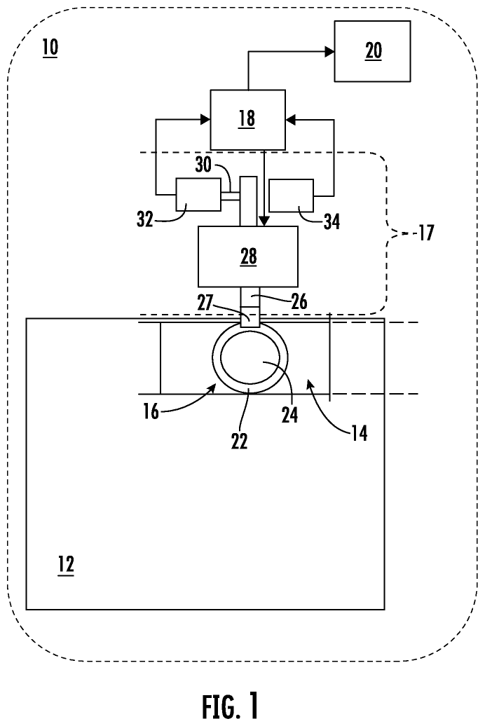

An aircraft system, in the form of an aircraft fuel system, generally designated 10, is illustrated schematically in FIG. 1.

The aircraft fuel system 10 comprises a fuel storage tank 12, a conduit 14, a valve 16, a valve actuator 17, a controller 18, and an indicator 20.

The fuel storage tank 12 is any appropriate fuel storage tank for use in an aircraft, and comprises a container within which fuel is housed in use. It will be appreciated that there may be many such fuel storage tanks 12 located on any one aircraft. Similarly the conduit 14 is any appropriate conduit for use in an aircraft, and the conduit 14 defines both an inlet and an outlet of the fuel storage tank 12. In other examples the conduit 14 may define only one of an inlet or outlet of the fuel storage tank 12, with the other of the outlet and inlet of the fuel storage tank 12 provided by a further conduit of the fuel storage tank 12.

The valve 16 is located within the conduit 14, and comprises a ball valve. The valve 16 comprises a valve drive spindle 27 connected to a generally ball shaped main body 22, with a bore 24 formed therein. The main body 22 sits within a valve seat of the conduit 14, such that the main body 22, and hence the bore 24, is rotatable relative to the conduit 14 via the valve drive spindle 27. The main body 22 is rotatable within the conduit 14 through an angle of around 90 degrees, such that either the main body 22 is located in a first position in which the main body 22 interrupts fluid flow through the conduit 14, or the main body 22 is located in a second position where the bore 24 is located such that fluid can pass through the bore 24, either into or out of the fuel storage tank 12 through the conduit 14. The first position may be referred to as a closed position of the valve 16, whereas the second position may be referred to as an open position of the valve 16.

The valve actuator 17 comprises a shaft 26 and a motor 28. The shaft 26 is connected to the main body 22 of the valve 16 via the valve drive spindle 27, and the motor 28 is operable, in response to a command issued by the controller 18, to cause rotation of the shaft 26, and consequently the valve drive spindle 27, to move the main body 22 between the first and second positions, ie the closed and open positions, discussed above. The motor 28 may be thought of as a driver of the valve 16. The shaft 26 is provided with a projection 30, and first 32 and second 34 microswitches are located adjacent to the shaft 26 The projection 30 contacts the first microswitch 32 when the main body 22 of the valve 16 is in the first, closed, position, such that the first microswitch 32 is closed when the main body 22 of the valve 16 is in the closed position, and the projection 30 contacts the second microswitch 34 when the main body 22 of the valve 16 is in the second, open, position, such that the second microswitch 34 is closed when the main body 22 of the valve 16 is in the open position.

The first 32 and second 34 microswitches are connected to the controller 18, such that the controller 18 knows when the main body 22 of the valve 16 is in either of the first, closed, and second, open, positions, or in transition between the first, closed, and second, open, positions.

The controller 18 comprises a processor, and the controller 18 is configured to provide commands to the motor 28 to drive actuation of the main body 22 of the valve 16 between its first, closed, and second, open, positions. The controller 18 may, in some examples, derive the commands based on inputs received from other systems of the aircraft in which the aircraft fuel system 10 is installed. The controller 18 comprises a clock, or counter, which may be used to monitor actuation of the valve 16 as will be described in more detail hereinafter. The controller 18 may communicate details of actuation of the valve 16 to the indicator.

The indicator 20 may take many forms, as will be described hereinafter, and is capable of providing an indication of an operating condition, or an altered operating condition, of the valve 16. In the example of FIG. 1 the indicator 20 is depicted as being part of the aircraft fuel system 10, although it will be appreciated that other examples, where the indicator forms part of the wider aircraft or is located remote from the aircraft, for example at an on-ground location, are also envisaged. The indicator 20 in FIG. 1 is depicted as coupled to the controller 18, although it will be appreciated that in some examples the controller 18 may itself provide an indication of an operating condition, or an altered operating condition, of the valve 16 by way of data generated by or output by the controller 18.

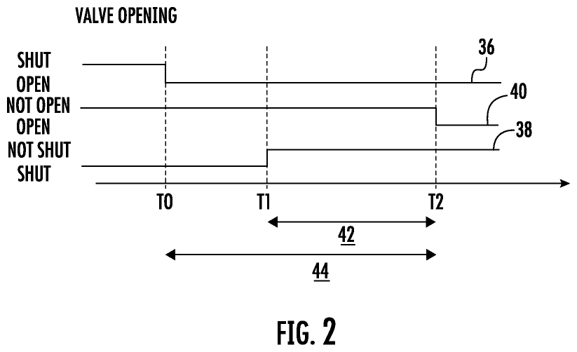

Actuation of the valve 16 between a closed position and an open position is illustrated schematically in FIG. 2.

The controller 18 provides a command signal 36 to actuate the motor 28 to turn the shaft 26 to open or close the valve 16 via the valve drive spindle 27, with the command signal 36 variable between a logic high state indicative of a valve shut command, and a logic low state indicative of a valve open command.

The first microswitch 32 provides a “shut” feedback signal 38 to the controller 18, with the shut feedback signal 38 variable between a logic low state indicative of the first, closed, position of the valve 16, and a logic high state indicative of a non-closed position of the valve 16. The logic low state of the shut feedback signal 38 is provided when the projection 30 contacts the first microswitch 32, whereas the logic high state of the shut feedback signal 38 is provided when the projection 30 does not contact the first microswitch 32.

The second microswitch 34 provides an “open” feedback signal 40 to the controller 18, with the open feedback signal 40 variable between a logic low state indicative of the second, open, position of the valve 16, and a logic high state indicative of a non-open position of the valve 16. The logic low state of the open feedback signal 40 is provided when the projection 30 contacts the second microswitch 34, whereas the logic high state of the open feedback signal 40 is provided when the projection 30 does not contact the first microswitch 32.

It will be appreciated that the functions of the logic high and logic low states discussed above may be reversed, if so desired.

It can be seen that in the example of FIG. 2, the valve 16 transitions from the first, closed, position, to the second, open, position.

At a time T0, the command signal 36 provided by the controller 18 transitions from its logic high state to its logic low state, indicating a desire to open the valve 16 to allow fuel to flow into or out of the fuel storage tank 12. Given delays in processing, the signal reaching the motor 28, and the motor 28 being energised, at a later time T1 the shaft 26 is turned such that the projection 30 no longer contacts the first microswitch 32. Hence at time T1 the closed feedback signal 38 transitions from its logic low state to its logic high state, indicating that the valve 16 is not closed. At time T1, the open feedback signal 40 remains in its logic high state, indicating that the valve 16 is not open.

At a later time T2, the shaft 26 has turned to move the main body 22 of the valve 16 from its first, closed, position to its second, open position, and the projection 30 contacts the second microswitch 34. Thus, at T2 the open feedback signal 40 transitions from its logic high state to its logic low state, indicating that the valve 16 is open.

The controller 18 monitors the times TO, T1 and T2, and these times can be utilized to determine altered operating conditions of the valve 16. An altered operating condition associated with actuation of the valve 16 may comprise an operating condition where the valve is functioning in an unintended manner, for example due to wear, friction or altered operating conditions of the motor. An altered operating condition associated with actuation of the valve may comprise an operating condition where the time taken for the valve to open or close is longer than a pre-determined nominal acceptable time. It will be appreciated that T1 and T2 may also be refer to the transition of the open feedback signal 40 from its logic low state to its logic high state, and the transition of the closed feedback signal 38 from its logic high state to its logic low state, respectively, in the event of the valve 16 closing rather than opening.

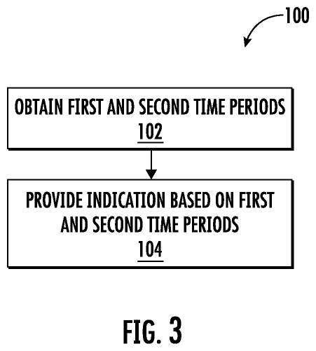

A method 100 of determining an operating condition of the valve 16 is illustrated schematically in FIG. 3, and comprises obtaining 102 a first time period associated with actuating the valve 16, and a second time period associated with actuating the valve 16, and providing 104 an indication of an altered operating condition associated with actuation of the valve 16 based on the first and second time periods.

It will be appreciated that the first and second time periods may be utilized in different manners, as will be described hereinafter.

For example, a first time period 42, from T1 to T2, may be measured and utilized, and the first time period 42 may be referred to as a feedback to feedback period given that it is dependent on feedback from both the first 32 and second 34 microswitches. The first time period 42, in general, comprises a time period indicative of how long it takes the main body 22 of the valve 16 to rotate between its first, closed, position and its second, open, position, or vice versa.

A second time period 44, from T0 to T2, may additionally or alternatively be measured and utilized, and the second time period 44 may be referred to as a command to feedback period given that it is dependent on the command to open or close the valve 16 provided by the controller 18, and feedback from either the second microswitch 34 or the first microswitch 32 dependant on whether the valve 16 is opening or closing.

In one example, the first time period 42 may be utilized to determine an altered operating condition associated with actuation of the valve 16. During a single flight of an aircraft 300 in which the aircraft fuel system 10 is installed, the controller 18 monitors the first time period 42 each time the valve 16 is actuated, ie either opened or closed. The controller 18 either stores in memory of the aircraft 300, or transmits to and stores in a remote memory location, the first time period 42 having a largest value for that flight. In some examples, each first time period 42 that occurs may be recorded, although it will be appreciated that this may require greater memory capacity.

This process is repeated over a number of flights of the aircraft 300, with each first time period 42 having a largest value for a given flight either stored in memory of the aircraft 300, or transmitted to and stored in a remote memory location. Each stored value of the first time period 42 is compared to a threshold value indicative of a normal operating condition of the valve 16. The threshold value may be chosen to be lower than a value which would cause an in-flight abnormal operating condition warning to be provided. Where a pre-determined number of first time periods 42 exceed the threshold value within a pre-determined time window, an indication of an altered operating condition associated with actuation of the valve 16 is provided.

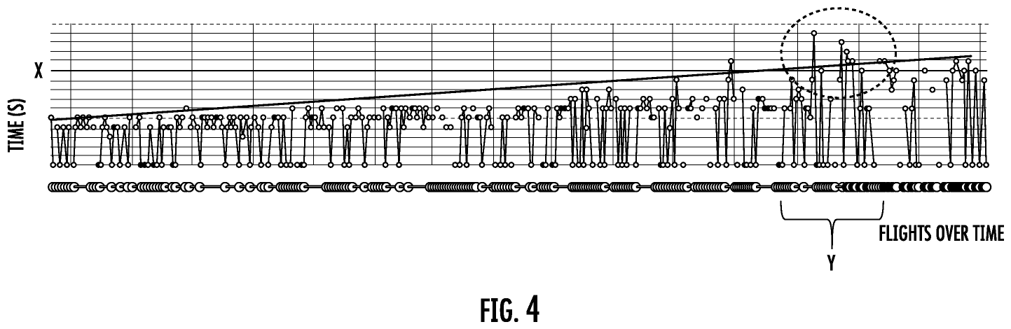

Examples of stored first time periods 42 are illustrated in the graph of FIG. 4, with each point corresponding to a first time period 42. Here, the threshold value for the first time period 42 is illustrated as X. In some examples, X is in the region of six to fourteen seconds, for example around ten seconds. Where stored first time periods 42 for a pre-determined number of flights, say a number of flights between two and fifty flights within a time window, labelled Y in FIG. 4, exceed the threshold value X, an indication of an altered operating condition associated with actuation of the valve 16 is provided. Such a situation is illustrated in the circled region of the graph of FIG. 4. The time window Y may be in the region of ten days to fifty days, for example around thirty days. In some examples, the pre-determined number of flights may be around five flights within the last fifty flights.

As will be appreciated, the indication may take many forms. For example, where the controller 18 stores the first time periods 42 in local memory of the aircraft 300, when a first time period 42 is determined that causes the above-mentioned criteria to be met, the indicator 20 may provide a visual indication to flight crew of the aircraft, in the form of an illuminated light or an on-screen message, that an altered operating condition associated with actuation of the valve 16 has been determined. In such a circumstance, the flight crew of the aircraft 300 may record the indication in a log and/or flag the indication to on-ground maintenance personnel such that the valve 16 and/or the valve actuator 17 can be examined and replaced as required.

In some examples, the comparison steps may be performed by the controller 18, with the indication of an altered operating condition associated with actuation of the valve 16 being transmitted from the controller 18 to a method indicator 20 for display by the indicator 20. For example, comparative and/or computational steps may be performed by the controller 18, with the remote indicator 20 being used to display the indication to on-ground maintenance personnel. The indication in such examples may comprise an illuminated light or an on-screen message, or a visual representation such as the graph of FIG. 4.

In some examples, where the controller 18 transmits the first time periods 42 for storage in remote memory, and the indicator 20 is located remotely from the aircraft 300, comparative and/or computational steps may be performed remotely from the aircraft 300 based on data transmitted by the controller 18, with the indicator 20 communicating the indication of an altered operating condition associated with actuation of the valve 16 to on-ground maintenance personnel. The indication in such examples may comprise an illuminated light or an on-screen message, or a visual representation such as the graph of FIG. 4.

While visual forms of indication have been described above, it will be appreciated that other forms of indication, for example aural indications, are also envisaged. Furthermore, it will be appreciated that the raw data values of the first time periods 42 itself, for example raw data values indicating the length, the start, or the end, of the first time period 42, may be considered an indication of an altered operating condition associated with actuation of the valve 16, given that an altered operating condition may be derived from the raw data values.

In other examples, both the first 42 and second 44 time periods may be utilized to determine an altered operating condition associated with actuation of the valve 16.

During a single flight of an aircraft 300 in which the aircraft fuel system 10 is installed, the controller 18 monitors the first time period 42 and the second time period 44 each time the valve 16 is actuated, i.e. either opened or closed. The controller 18 either stores in memory of the aircraft 300, or transmits to and stores in a remote memory location, the first time period 42 having a largest value for that flight and the second time period 44 having a largest value for that flight, and/or the second time period 44 having a largest value for that flight and its corresponding first time period 42. In some examples, each first time period 42 and each second time period 44 that occurs may be recorded, although it will be appreciated that this may require greater memory capacity.

It has been found that a comparison between the first 42 and second 44 time periods may be utilized to distinguish between different altered operational modes of the valve 16.

For example, where both the first time period 42 and the second time period 44 are above corresponding threshold values, the valve 16 may comprise an operating condition where the time taken for the valve 16 to open and/or close is longer than a nominal time taken during a normal operating condition. High values for both the first 42 and second 44 time periods may indicate is a greater amount of friction during the movement of the shaft 26 and/or the movement of the main body 22 of the valve 16 compared to a nominal normal operating condition.

Where the first time period 42 is below a corresponding threshold value, and the second time period 44 is above a corresponding threshold value, the valve 16 may comprise an operating condition where the time taken for the valve 16 to open and/or close is longer than a nominal time taken during a normal operating condition. A relatively high value for the second time period 44 and a relatively low value for the first time period 42 may be indicative of a greater amount of static friction in the shaft 26 and motor 28 or in the valve 16 compared to a nominal normal operating condition. This may be viewed as the time period TO to T1, ie the time period from when a command is issued by the controller to the valve 16 moving away from a closed or open position, being longer than a nominal corresponding time period of a normal operating condition.

Where the first time period 42 is above a corresponding threshold value, and the second time period 44 is below a corresponding threshold value, this may be indicative of the closed feedback signal 38 or the open feedback signal changing state without a change in state of the command signal 36. This may, for example, occur where the projection 30 of the shaft 36 moves out of contact with a corresponding microswitch 32,34 in the absence of a command signal, where one of the microswitches 32,34 experiences an abnormal operating condition, or where there is an unintentional change in electrical connection or wiring.

In some examples, the threshold value may be the same value for each of the first 42 and second 44 time periods.

While in some examples first 42 and second 44 time periods from a single flight may be used to determine an abnormal operating condition associated with actuation of the valve 16, in other examples first 42 and second 44 time periods from multiple flights may be utilized, similar to the example discussed above where the first time period 42 is used without using the second time period 44.

In particular, appropriate first 42 and second 44 time periods for a given flight are either stored in memory of the aircraft 300, or transmitted to and stored in a remote memory location. Each stored value of the first 42 and second 44 time periods is compared to a threshold value indicative of a normal operating condition of the valve 16. The threshold value may be chosen to be lower than a value which would cause an in-flight abnormal operating condition warning to be provided. Where a pre-determined number of first 42 and second 44 time periods have the relationships described above relative to the threshold value (i.e. first time period 42 high and second time period 44 high, second time period 44 high and first time period 42 low, or first time period 42 high and second time period 44 low) within a pre-determined time window, an indication of an altered operating condition associated with actuation of the valve 16 is provided.

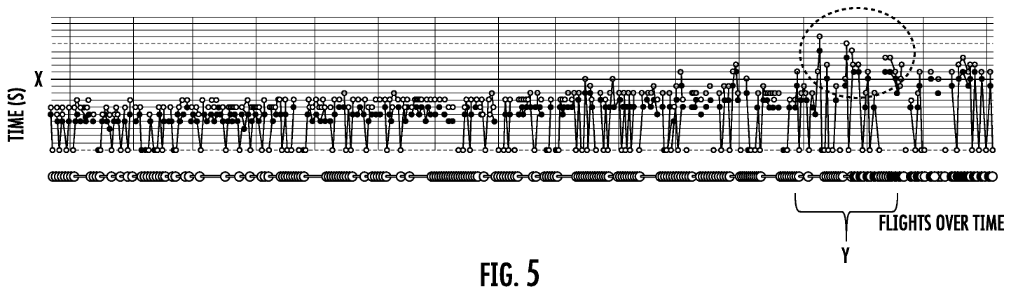

Examples of stored first 42 and second 44 time periods are illustrated in the graph of FIG. 5, with first 42 and second 44 time periods occurring in pairs, with the higher value of a pair being the second time period 44 and the lower value of the pair being the first time period 42.

As in relation to the example of FIG. 4 above, the indication in relation to the example of FIG. 5 may take many forms. For example, where the controller 18 stores the first 42 and second 44 time periods in local memory of the aircraft 300, when a relationship is determined that causes the above-mentioned criteria to be met, the indicator 20 may provide a visual indication to flight crew of the aircraft 300, in the form of an illuminated light or an on-screen message, that an altered operating condition associated with actuation of the valve 16 has been determined. In such a circumstance, the flight crew of the aircraft 300 may record the indication in a log and/or flag the indication to on-ground maintenance personnel such that the valve 16 and/or the valve actuator 17 can be examined and replaced as required.

In some examples, the comparison steps may be performed by the controller 18, with the indication of an altered operating condition associated with actuation of the valve 16 being transmitted from the controller 18 to a method indicator 20 for display by the indicator 20. For example, comparative and/or computational steps may be performed by the controller 18, with the remote indicator 20 being used to display the indication to on-ground maintenance personnel. The indication in such examples may comprise an illuminated light or an on-screen message, or a visual representation such as the graph of FIG. 5.

In some examples, where the controller 18 transmits the first 42 and second 44 time periods for storage in remote memory, and the indicator 20 is located remotely from the aircraft 300, comparative and/or computational steps may be performed remotely from the aircraft 300 based on data transmitted by the controller 18, with the indicator 20 communicating the indication of an altered operating condition associated with actuation of the valve 16 to on-ground maintenance personnel. The indication in such examples may comprise an illuminated light or an on-screen message, or a visual representation such as the graph of FIG. 5.

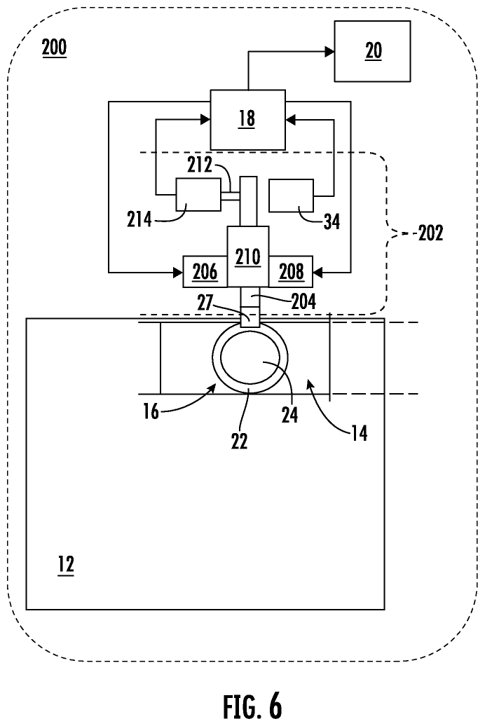

In the examples previously described, the aircraft fuel system 10 has a valve 16 actuated by one motor 28. In other examples, valves of aircraft fuel systems may be actuated by more than one motor. Such an example is illustrated schematically in FIG. 6, where like reference numerals are utilized for sake of clarity. Here, an aircraft fuel system 200 has a fuel storage tank 12, a conduit 14, a valve 16, a controller 18, and an indicator 20, as previously described.

The aircraft fuel system 200 further has a valve actuator 202, which differs from the valve actuator 17 of the example of FIG. 1 in that the valve actuator 202 comprises a shaft 204, a first motor 206, a second motor 208, and gearing 210. The shaft 204 is connected to the main body 22 of the valve 16 via the valve drive spindle 27, and the first 206 and second 208 motors are operable, in response to a command issued by the controller 18, to cause rotation of the shaft 204, via the gearing 210 to move the main body 22 via the valve drive spindle 27 between the first and second positions, ie the closed and open positions, discussed above in relation to the example of FIG. 1. The first 206 and second 208 motors may be thought of as first and second drivers of the valve 16 respectively. The shaft 204 is provided with a projection 212, and first 214 and second 216 microswitches are located adjacent to the shaft 204. The projection 212 contacts the first microswitch 214 when the main body 22 of the valve 16 is in the first, closed, position, such that the first microswitch 214 is closed when the main body 22 of the valve 16 is in the closed position, and the projection 212 contacts the second microswitch 216 when the main body 22 of the valve 16 is in the second, open, position, such that the second microswitch 216 is closed when the main body 22 of the valve 16 is in the open position.

It will therefore be appreciated that the first time period 42 and the second time period 44 discussed in relation to the example of FIG. 1 may also be obtained in relation to actuation of the valve 16 of the aircraft fuel system 200 of FIG. 6.

It has been found that by monitoring the first time period 42 or the first time period 42 and the second time period 44 over a number of flights as previously described, an altered operating condition associated with actuation of the valve 16 may be determined, with the altered operating condition caused by an altered operating condition of at least one of the first 206 and second 208 motors. For example, where the first motor 206 experiences greater load torque than in a nominal operating condition, it may take longer for the valve 16 to be opened and/or closed, resulting in the first time period 42 and the second time period 44 being longer. It will be appreciated that examples where both the first 42 and second 44 time periods are used to identify and/or distinguish between altered operating conditions associated with actuation of the valve 16 of the aircraft fuel system 200 of FIG. 6 are also envisaged, similar to the example discussed above in relation to the aircraft fuel system 10 of FIG. 1.

In the examples described above, it will be appreciated that time periods associated with actuation of the valve 16 may be used to determine an altered operating condition associated with actuation of the valve 16.

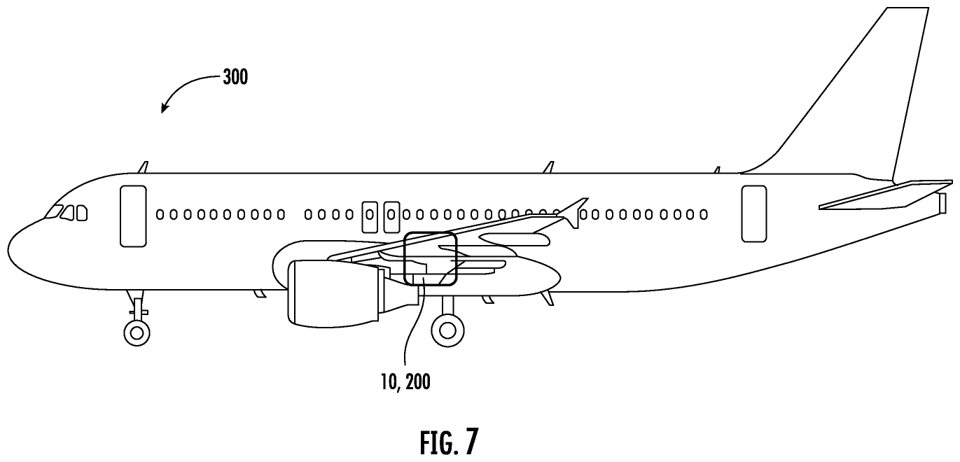

An aircraft 300 comprising the aircraft fuel system 12 of FIG. 1, or the aircraft fuel system 200 of FIG. 6 is illustrated schematically in FIG. 7.

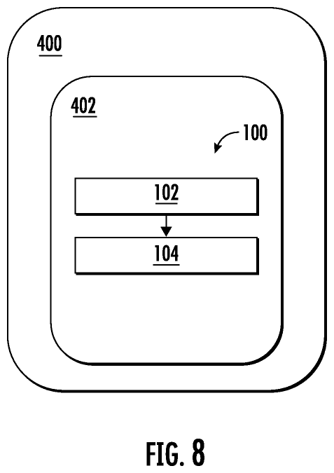

A data carrier 400 is illustrated schematically in FIG. 8, and comprises machine readable instructions 402 which cause operation of a processor of the aircraft fuel system 10 of FIG. 1 or the aircraft fuel system 200 of FIG. 6 to obtain time periods associated with actuation of the valve 16, and provide an indication of an altered operating condition associated with actuation of the valve 16 based on the obtained time periods.

While described herein in relation to an aircraft fuel system it will be appreciated that the teaching may be more generally applied to any aircraft system utilizing a valve, including, for example, an aircraft environmental control system.

It is to be noted that the term “or” as used herein is to be interpreted to mean “and/or”, unless expressly stated otherwise.

It should be understood that modifications, substitutions, and alternatives of the present invention(s) may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method of determining an operating condition of a valve of an aircraft system, the method comprising:
obtaining a first time period associated with actuating the valve, and a second time period associated with actuating the valve; and
providing an indication of an altered operating condition associated with actuation of the valve based on the first and second time periods.

2. The method according to claim 1, wherein the first time period is associated with a first actuation of the valve, and the second time period is associated with a second actuation of the valve different to the first actuation of the valve.

3. The method according to claim 1, wherein the valve is actuable between first and second positions, the first time period is associated with a first actuation of the valve from the first position to the second position or vice versa, and the second time period is associated with a second actuation of the valve from the first position to the second position or vice versa.

4. The method according to claim 1, comprising comparing each of the first and second time periods to a threshold value, and where each of the first and second time periods exceeds the threshold value, providing the indication of the altered operating condition associated with actuation of the valve.

5. The method according to claim 1, wherein the first time period is associated with actuating the valve during a first flight in which the aircraft system is utilized, and the second time period is associated with actuating the valve during a second flight in which the aircraft system is utilized, the second flight different to the first flight.

6. The method according to claim 5, comprising providing the indication of the altered operating condition associated with actuation of the valve where the first and second flights occur within a pre-determined time window.

7. The method according to claim 5, wherein the valve is actuated a plurality of times in the first flight, and the method comprises obtaining a first plurality of time periods each corresponding to a respective actuation of the valve during the first flight, and selecting the first time period from the first plurality of time periods based on a length of each of the first plurality of time periods, wherein the valve is actuated a plurality of times in the second flight, and the method comprises obtaining a second plurality of time periods each corresponding to a respective actuation of the valve during the second flight, and selecting the second time period from the second plurality of time periods based on a length of each of the second plurality of time periods.

8. The method according to claim 1, comprising obtaining at least four different time periods associated with actuating the valve, each time period associated with actuating the valve during a different respective flight of a plurality of flights, comparing each time period to a corresponding threshold value, and, where each time period exceeds the threshold value and the plurality of flights occur within a pre-determined time window, providing the indication of the altered operating condition associated with actuation of the valve.

9. The method according to claim 1, wherein the valve is movable from a first position to a second position in response to a command, the first time period comprises a time taken for the valve to move from the first position to the second position, and the second time period comprises a time taken from issuance or receipt of the command to the valve reaching the second position.

10. The method according to claim 9 wherein the first time period and the second time period are associated with a same actuation of the valve.

11. The method according to claim 9, comprising performing a comparison of the first time period to a parameter, and providing the indication of the altered operating condition associated with actuation of the valve based on the comparison.

12. The method according to claim 11, comprising performing a further comparison of the second time period to a further parameter, and providing the indication of the altered operating condition associated with actuation of the valve based on the comparison and the further comparison.

13. The method according to claim 12, wherein the parameter comprises a nominal time taken for the valve to move from the first position to the second position, and the further parameter comprises a nominal time taken from issuance or receipt of the command to the valve reaching the second position.

14. The method according to claim 12, comprising:
where the first time period exceeds the parameter and the second time period exceeds the further parameter, providing an indication of a first altered operating condition associated with actuation of the valve;
where the first time period exceeds the parameter and the second time period does not exceed the further parameter, providing an indication of a second altered operating condition associated with actuation of the valve different to the first altered operating condition associated with actuation of the valve; and
where the first time period does not exceed the parameter and the second time period exceeds the further parameter, providing an indication of a third altered operating condition associated with actuation of the valve different to the first and second altered operating conditions of the valve.

15. The method according to claim 11, wherein the parameter comprises the second time period.

16. The method according to claim 1, wherein the valve comprises first and second drivers, the first time period is associated with actuation of the valve by the first and second drivers at a first point in time, the second time period is associated with actuation of the valve by the first and second drivers at a second point in time different to the first point in time, and, where the second time period is greater than the first time period, the method comprising providing an indication of an altered operating condition of at least one of the first and second actuators.

17. The method according to claim 1, wherein the aircraft system comprises an aircraft fuel supply system.

18. A data carrier comprising machine readable instructions for operation of one or more processors of an aircraft system to obtain a first time period associated with actuating a valve, and a second time period associated with actuating the valve, and provide an indication of an altered operating condition associated with actuation of the valve based on the first and second time periods.

19. An aircraft system comprising a valve, a controller configured to obtain a first time period associated with actuating the valve, and a second time period associated with actuating the valve, and an indicator configured to provide an indication of an altered operating condition associated with actuation of the valve based on the first and second time periods.

20. An aircraft fuel system comprising a fuel storage tank, a conduit in fluid communication with the fuel storage tank, a valve to selectively enable transfer of fuel into and/or out of the fuel storage tank, the valve located within the conduit, a controller, and an indicator, the controller configured to monitor a plurality of time periods associated with actuation of the valve between an open position and a closed position, or vice versa, each of the plurality of time periods taken during a different flight of an aircraft comprising the aircraft fuel system, and compare each of the plurality of time periods to a corresponding parameter, and the indicator configured to provide an indication that the valve is operating in an altered operating condition relative to a normal operating condition of the valve based on the comparisons.

21. An aircraft comprising the aircraft system of claim 19.
